(19) United States
(12) Patent Application Publication
(10) Pub. No.: US 2007/0029715 A1
(43) Pub. Date: Feb. 8, 2007

(54) Secondary workbench for belt-type sawing machine

(76) Inventor: Hsu Hsiu-Kwei Liu, Taichung (TW)

Correspondence Address: TROXELL LAW OFFICE PLLC, SUITE 1404, 5205 LEESBURG PIKE, FALLS CHURCH, VA, 22041, US

(21) Appl. No.: 11/171,334

(22) Filed: Jul. 1, 2005

(51) Int. Cl. B25B 1/02

(52) U.S. Cl. 269/139

(57) ABSTRACT

A secondary workbench for belt-type sawing machine includes two side frames and a transverse frame located between the two side frames. Each of the side frames includes a base frame, a roller mounted on the base frame, and a telescopic leg pivotally connected to a rear lower end of the base frame. The transverse frame is connected at two ends to front ends of the two base frames, so that a smaller saw bench of a belt-type sawing machine could be connected to a top of the transverse frame to locate between the two rollers of the secondary workbench and thereby has an expanded bench area, allowing a relatively big workpiece to be positioned on the rollers and the saw bench for sawing.

### FIELD OF THE INVENTION

The present invention relates to a secondary workbench that can be conveniently connected to an existing saw bench of a belt-type sawing machine, so that the belt-type sawing machine may have an expanded workbench to facilitate sawing of a relatively big workpiece.

### BACKGROUND OF THE INVENTION

A currently available belt-type sawing machine typically includes a saw bench having a fixed size. To save as much as possible the space to be occupied by the belt-type sawing machine in a plant building, the belt-type sawing machine and the saw bench thereof are normally designed to have a volume as small as possible. The small saw bench is particularly inconvenient for use when a relatively big workpiece is to be sawn. It is therefore tried by the inventor to develop a secondary workbench for belt-type sawing machine to overcome the problem encountered by the conventional belt-type sawing machines.

### SUMMARY OF THE INVENTION

A primary object of the present invention is to provide a secondary workbench that could be conveniently connected to a saw bench of a belt-type sawing machine, so that the saw bench may have an expanded area to facilitate sawing of a relatively big workpiece.

Another object of the present invention is to provide a secondary workbench that could be detachably connected to a belt-type sawing machine for use, or folded to occupy only a reduced space for convenient carrying, transporting, and storage when it is not in use and detached from the sawing machine.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a partially exploded perspective view of a secondary workbench for belt-type sawing machine according to the present invention;

FIG. 2 is an assembled perspective view of FIG. 1;

FIG. 3 is similar to FIG. 2 but with one leg of the secondary workbench in a folded position;

FIG. 4 shows the secondary workbench of the present invention is connected to a saw bench of a belt-type sawing machine; and

FIG. 5 shows the positioning of a relatively big workpiece on the secondary workbench of the present invention.

### DETAILED DESCRIPTION OF THE PREFERRED EMBODIMENTS

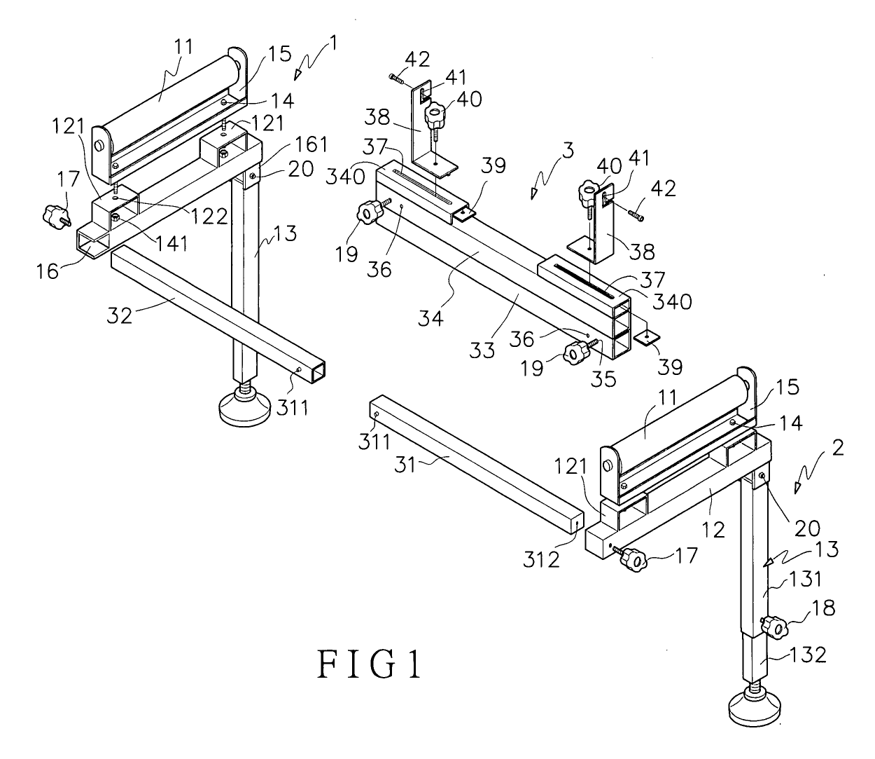

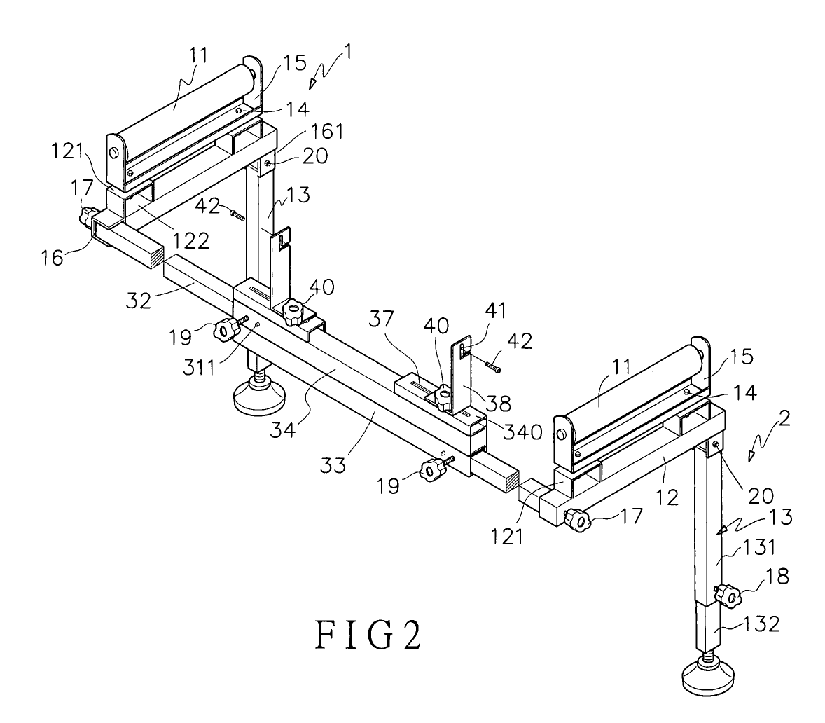

Please refer to FIGS. 1 and 2 that are partially exploded and fully assembled perspective views, respectively, of a secondary workbench for belt-type sawing machine according to a preferred embodiment of the present invention. As shown, the secondary workbench of the present invention includes two side frames 1, 2 and a transverse frame 3.

Since the two side frames 1, 2 are structurally identical, only one of them is described herein. The side frame 1 includes a roller 11 mounted on a roller support 15, a base frame 12 located below the roller support 15, and a leg 13 connected to an end of the base frame 12.

The base frame 12 is provided at a front end with a sideward opening 16, at a rear end with a bottom opening 161, and at a top with two spaced and upward projected seat frames 121. The seat frames 121 are provided at respective top with a threaded hole 122, and two screws 14 may be downward extended through the roller support 15 and the threaded holes 122 on the seat frames 121 to engage with a nut 141 each, so that the roller support 15 is locked to the top of the base frame 12.

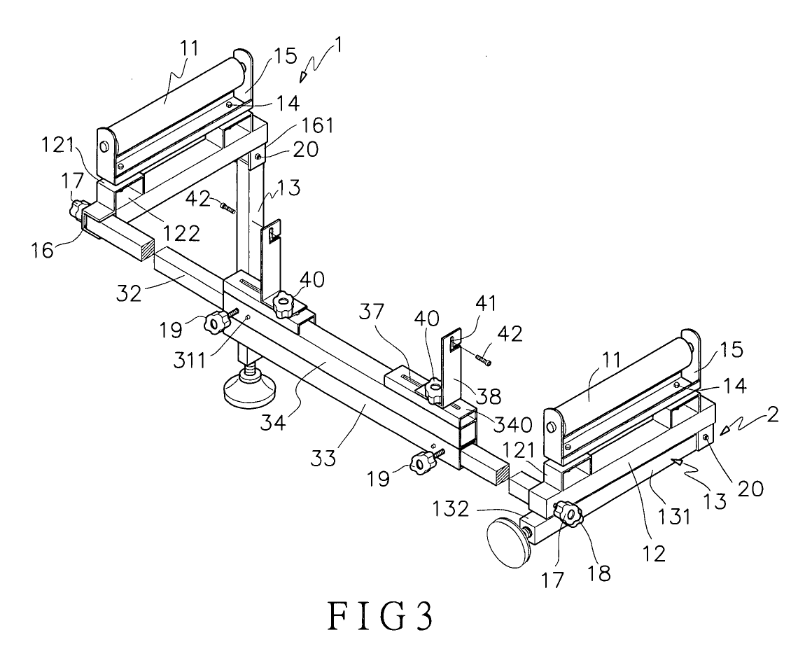

The leg 13 has an upper end received in the bottom opening 161 at the rear end of the base frame 12, and is pivotally connected thereto with a screw 20. When the screw 20 is loosened, the leg 13 may be upward turned about the screw 20 to a folded position, as shown in FIG. 3. The leg 13 is a telescopic leg including an outer pipe 131 and an inner pipe 132 slidably fitted in the outer pipe 131. By sliding the inner pipe 132 relative to the outer pipe 131, and locking the two pipes 131, 132 in place using a screw 18, the leg 13 may be adjusted and fixed to any desired height.

A magnet (not shown) may be embedded in each base frame 12 near a lower front end thereof, so that the leg 13 in the pivotally turned and upward folded position may be further magnetically held in place below the base frame 12.

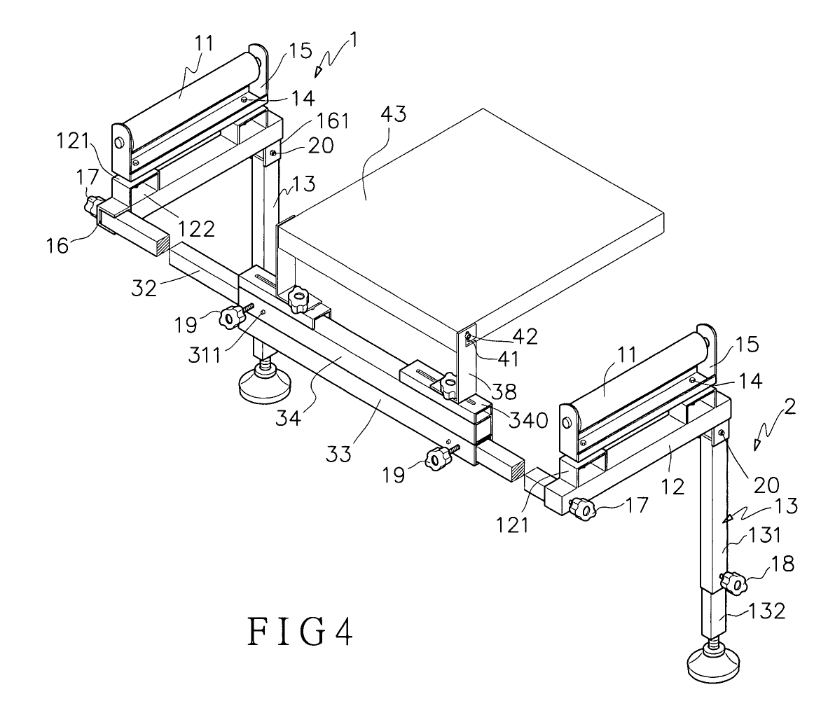

The transverse frame 3 includes two transverse tubes 31, 32, and a long seat consisting of an upper and a lower hollow tube 33, 34 having a cross sectional shape corresponding to that of the transverse tubes 31, 32, respectively. Each of the two transverse tubes 31, 32 has a ball 311 elastically mounted in and protruded from a distal end thereof, and is provided at a proximal end surface with a screw hole 312. The upper and the lower hollow tube 33, 34 are provided at a predetermined position on respective front surface with a set of screw hole 35 and through hole 36 each. The two transverse tubes 31, 32 are fixedly connected at the proximal ends to the sideward openings 16 on the two base frames 12 using screws 17, and are inserted into the upper and lower hollow tubes 33, 34, respectively, with the balls 311 at the distal ends of the transverse tubes 31, 32 elastically protruded into the through holes 36 on the hollow tubes 33, 34 to prevent the transverse tubes 31, 32 from moving outward. Two screws 19 are further extended through the screw holes 35 on the two hollow tubes 33, 34 to press against and thereby firmly hold the two transverse tubes 31, 32 in the two hollow tubes 33, 34. The upper hollow tube 34 is provided on a top near two ends thereof with a seat frame 340 each. Each of the seat frames 340 is provided at a top with a guide slot 37, to which an L-shaped bracket 38 is movably screwed via a washer 39 and a screw 40, so that the L-shaped bracket 38 is adjustably located on the top of the upper hollow tube 34. The two L-shaped brackets 38 are provided near respective upper end with a slot 41 each, such that two screws 42 may be threaded through the slots 41 into two opposite side surfaces of an existing saw bench 43 of a belt-type sawing machine, as shown in FIG. 4.

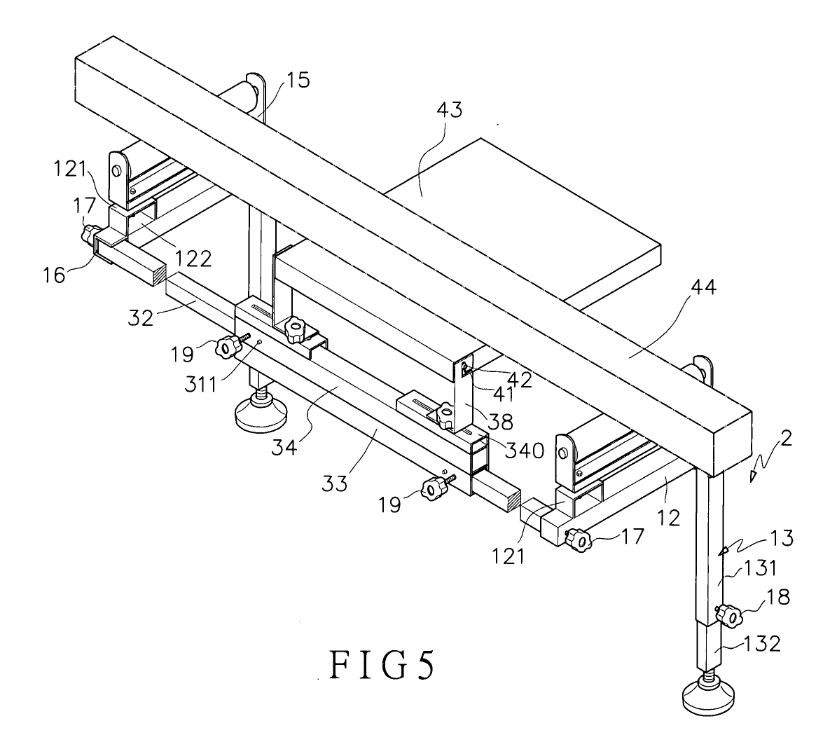

Please refer to FIGS. 4 and 5 at the same time. To connect the secondary workbench of the present invention to the belt-type sawing machine, first symmetrically assemble the two side frames 1, 2 to two ends of the transverse frame 3 in the manner described in the previous paragraphs, and then screw the two L-shaped brackets 38 to the two side surfaces of the saw bench 43 of the sawing machine, so that the secondary workbench and the saw bench 43 form an integral body. A relatively big workpiece 44 may be then positioned on the two rollers 11 and the saw bench 43 to be conveniently moved in a laborsaving manner.

What is claimed is:

1. A secondary workbench for belt-type sawing machine, comprising:
two side frames, each of which including a roller, a base frame, and a leg; and
a transverse frame located between said two side frames and including two transverse tubes and a long seat.

2. The secondary workbench for belt-type sawing machine as claimed in claim 1, wherein said roller is mounted on a roller support, and said roller support is locked to a top of said base frame via screws and nuts.

3. The secondary workbench for belt-type sawing machine as claimed in claim 1, wherein each of said base frames is provided at a front end with a sideward opening, via which each of said two transverse tubes of said transverse frame is connected at a proximal end to said side frame.

4. The secondary workbench for belt-type sawing machine as claimed in claim 1, wherein each of said base frames is provided at a rear end with a bottom opening, via which each of said two legs is connected to said base frame using screws.

5. The secondary workbench for belt-type sawing machine as claimed in claim 4, wherein said leg screwed to the rear end of said base frame via said bottom opening is pivotally and upward turnable about said screws relative to said base frame to a folded position when said screws are loosened.

6. The secondary workbench for belt-type sawing machine as claimed in claim 4, wherein each of said two legs is a telescopic leg including an outer tube and an inner tube slidably fitted in said outer tube.

7. The secondary workbench for belt-type sawing machine as claimed in claim 1, wherein each of said two base frames is provided at a top with two spaced and upward projected seat frames, said seat frames being provided at respective top with a threaded hole each, whereby two screws may be separately downward extended through said roller support and said threaded holes to engage with a nut each to thereby lock said roller support to the top of said base frame.

8. The secondary workbench for belt-type sawing machine as claimed in claim 1, wherein said long seat of said transverse frame consists of an upper and a lower hollow tube, and said upper and lower hollow tube being provided at a predetermined position on respective front surface with a set of screw hole and through hole each.

9. The secondary workbench for belt-type sawing machine as claimed in claim 1, wherein said transverse frame is provided on a top near two ends thereof with a seat frame each; and each of said two seat frames being provided at a top with a guide slot.

10. The secondary workbench for belt-type sawing machine as claimed in claim 9, further comprising two L-shaped brackets, and each of said two L-shaped brackets being movably screwed to said guide slot on said seat frame.

11. The secondary workbench for belt-type sawing machine as claimed in claim 10, wherein each of said two L-shaped brackets is provided near an upper end with a slot.

12. The secondary workbench for belt-type sawing machine as claimed in claim 1, wherein each of said two transverse tubes of said transverse frame is provided near a distal end with a ball elastically embedded in and protruded from said transverse tube.

13. The secondary workbench for belt-type sawing machine as claimed in claim 1, wherein each of said two transverse tubes of said transverse frame is provided at a proximal end surface with a screw hole.
